(19) United States
(12) Patent Application Publication
(10) Pub. No.: US 2009/0148589 A1
(43) Pub. Date: Jun. 11, 2009

(54) CORN PROTEIN CONCENTRATES

(76) Inventors: Eugene J. Fox, Dayton, OH (US); Donald L. Shandera Jr., Ashland, NE (US); Eric Bell, Blair, NE (US)

Correspondence Address: FISH & RICHARDSON P.C., PO BOX 1022, MINNEAPOLIS, MN, 55440-1022, US

(21) Appl. No.: 11/997,820

(22) PCT Filed: Aug. 2, 2006
(86) PCT No.: PCT/US06/30266

§ 371 Date: Jul. 11, 2008

Related U.S. Application Data
(60) Provisional application No. 60/704,953, filed on Aug. 3, 2005.

(51) Int. Cl. A23J 1/12; A23K 1/16; A23K 1/18

(52) U.S. Cl. 426/648; 426/656

(57) ABSTRACT

The invention provides for corn protein concentrates (CPC). The CPC described herein can be used in feed products for consumption by companion animals and animals raised for commercial purposes.

### TECHNICAL FIELD

This invention relates to protein concentrates, and more particularly to corn protein concentrates.

### BACKGROUND

Corn wet milling is used to separate corn kernels into products such as starch, protein, fiber and oil. Corn wet milling is a two stage process: a steeping process to soften the corn kernel and to facilitate the next step; and a wet milling process resulting in purified starch and different co-products such as oil, fiber, and protein.

### SUMMARY

The invention provides for corn protein concentrates (CPC). The CPC described herein can be used in feed products for consumption by companion animals or animals raised for commercial purposes.

In one aspect, the invention provides a feed product for a companion animal that includes a corn protein concentrate. A corn protein concentrate according to the invention is prepared by a process that includes contacting one or more protein containing materials with one or more wet-mill streams and one or more carbohydrases, which produces at least one protein concentrate and at least one aqueous stream containing water-soluble carbohydrates, and separating the protein concentrate from the aqueous stream containing water-soluble carbohydrates.

A feed product as disclosed herein can be for a companion animal that includes, without limitation, dog, cat, bird, fish, potbelly pig, reptile, amphibian, and rodent. For example, a feed product as disclosed herein can include a pet food and/or pet treats (e.g., a biscuit, bar, chew, cookies, kibble, or toy). In some embodiments, the feed product is a nutritional supplement such as a biscuit, a bar, a chew, cookies, biscuits, kibble, an energy bar, an energy sauce or an energy drink.

A feed product as disclosed herein can enhance palatability. In some embodiments, the corn protein concentrate can be applied onto the surface of a pet food. A feed product as described herein has greater palatability than corn gluten meal or a feed made with corn gluten meal; results in greater satiety than a feed product containing corn gluten meal when fed to an animal; and/or allows for caloric density management. A feed product as described herein typically has a higher pH when compared to CGM (e.g., 4.8 to 5.6). The invention also provides for an animal feed comprising a feed product as described herein.

The process of making a corn protein concentrate as described herein further can include defatting the protein-containing material; decoloring, bleaching, and/or reducing the color-bodies present in the protein-containing material; contacting the corn protein concentrate with a deodorizing compound (e.g., a cyclodextrin); and/or contacting the one or more protein-containing materials with one or more phytases.

In a process of making a corn protein concentrate as described herein, the one or more wet-mill streams can include steep liquor, light steep water, heavy steep liquor, or mixtures thereof; the wet-mill stream can be derived from a gluten concentrating or mill thickening wet-mill stream such that the majority fraction of the mill stream is of a nitrogenous or protein content; the protein-containing material can be light gluten fraction, heavy gluten fraction, corn gluten concentrate, corn gluten meal, gluten cake, and mixtures thereof; and the carbohydrase can be alpha amylase, dextrinase, pullulanase, glucoamylase, hemicellulase, cellulase, and mixtures thereof.

A feed product as described herein can be extruded. Such an extruded feed product generally has a minimum oil content of 10% and a maximum oil content of 30%. The oil can be, for example, a vegetable oil (e.g., corn oil, soybean oil, canola oil, palm oil, rapeseed oil, peanut oil, and sunflower oil) or an animal oil (e.g., chicken fat, tallow, white grease, lard, and fish oil).

In another aspect, the invention provides an animal feed product that includes a corn protein concentrate that is prepared by a process that includes contacting one or more protein containing materials with one or more wet-mill streams and one or more carbohydrases, which produces at least one protein concentrate and at least one aqueous stream containing water-soluble carbohydrates, and separating the protein concentrate from the aqueous stream containing water-soluble carbohydrates.

Such an animal feed can be for chickens, turkeys, game birds, cattle, fish, pigs, sheep, wild birds, frogs, shrimp, snails, reptiles, amphibians, or rodents. Such an animal feed can be an aquafeed that, for example, contains less than 10% starch. An animal feed (e.g., an aquafeed) can exhibit expansion characteristics that contribute to the feeds density such that the feed floats, suspends, and/or sinks in a manner that make the pellet more palatable. An animal feed as disclosed herein can provide a concentrated source of methionine to the diet. In addition, the protein in an animal feed as disclosed herein also has desirable rumen bypass properties.

In another aspect, the invention provides a corn protein concentrate that has at least about 80% protein on a dry weight basis and substantially lacks one or more exogenous polypeptides having saccharification enzyme activity.

In still another aspect, the invention provides a corn protein concentrate, wherein, when the corn protein concentrate is compared to corn gluten meal, the corn protein concentrate: a) has a pH that consistently stays above about 5; b) has a lower wet milling odor; c) exhibits less bacterial counts; and/or d) has a lower ash content on a per protein basis. Typically, there is no significant difference in the protein digestibility by an animal between the corn protein concentrate and the corn gluten meal.

In other aspects, the invention provides a corn protein concentrate that has a lower water activity than corn gluten meal at a moisture content of less than 10%; and a corn protein concentrate including at least about 80% protein on a dry weight basis, less than about 5% of granular starch and about 1% to about 10% liquefied starch carbohydrates and sugars. Generally, at least 10% of the total water extractable carbohydrates (DP 1-13) in a corn protein concentrate as described herein come from the liquefied starch carbohydrates (DP 5-13).

In yet another aspect, the invention provides a corn protein concentrate, wherein, when the corn protein concentrate is compared to corn gluten meal following extrusion, the corn protein concentrate: a) exhibits more controllable expansion; b) exhibits greater expansion; c) exhibits more uniform cell structure; d) creates a more homogenous product; e) produces a kibble with a smoother surface; and/or f) exhibits greater oil binding capacity.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### DETAILED DESCRIPTION

The present invention provides for a corn protein concentrate that can be used in feed consumed by companion animals (e.g., pets) or by other animals (e.g., farm animals and other animals raised for commercial purposes).

### Corn Protein Concentrate (CPC)

A CPC described herein generally has at least 80% protein (on a dry weight basis) (e.g., 85%, 90%, 95%, 99%, or 100% on a dry weight basis). The CPC described herein is composed primarily of prolamines and glutelins based on the Osbourn Classification System of classifying proteins, which is based on the solubility or polypeptides in a solvent. A typical proximate analysis of a CPC described herein compared to corn gluten meal (CGM) is shown below.

| | CPC | CGM |
|---|---|---|
| Component | (as is) | (as is) |
| Protein | 75% | 60% |
| Fat (Ether Extractable) | 2.5% | 2% |
| Crude Fiber | 3% | 2.5% |
| Starch | <1% | 15% |
| Moisture | 10% | 10% |
| Xanthophyll (mg/lb) | 121 | 107 |
| Density (lb/cu ft) | 38-41 | 36-43 |

A typical amino acid analysis of CGM is shown below. The amino acid composition of a CPC described herein are not expected to differ significantly from that of CGM.

| Amino Acid | % of Total | % of Protein |
|---|---|---|
| Alanine | 5.94 | 7.92 |
| Arginine | 2.42 | 3.23 |
| Aspartic Acid | 4.40 | 5.87 |
| Cystine | 1.13 | 1.50 |
| Glutamic Acid | 15.5 | 20.7 |
| Glycine | 1.69 | 2.25 |
| Histidine | 1.76 | 2.35 |
| Isoleucine | 3.15 | 4.20 |
| Leucine | 12.9 | 17.3 |
| Lysine | 1.08 | 1.45 |
| Methionine | 1.59 | 2.12 |
| Phenylalanine | 4.65 | 6.20 |
| Proline | 6.95 | 9.27 |
| Serine | 4.07 | 5.42 |
| Threonine | 2.21 | 2.95 |
| Tryptophan | 0.30 | 0.40 |
| Tyrosine | 4.22 | 5.62 |
| Valine | 3.44 | 4.59 |

As used herein, CGM refers to the dried residue from corn after the removal of the larger part of the starch and germ and the separation of the bran by the process employed in the wet milling manufacture of corn starch or syrup, or by enzymatic treatment of the endosperm. CGM may contain fermented corn extractives and/or corn germ meal. The protein in CGM has low solubility in water and has rumen bypass properties.

Dry solids can be determined by drying of the material at 103° C. using a method adapted from Dutch standard method NEN 3332 and according to the American Association of Cereal Chemists (AACC) Official Method 44-15A or by using Official Methods of the AOAC International (AOAC), sec. 935.29.

Protein content of CPC in solution can be determined using, for example, a Bradford Protein Assay (Bradford, 1975, Anal. Biochem., 7:248). Total and soluble protein content can be determined according to AACC Method 46-30 or AOAC 990.03.

Starch content can be determined using a method derived from suitable official analytical methods such as Corn Refiners Association's (CRA) G-28. Total starch and liquefaction-produced carbohydrates can be determined by the AOAC Official Methods of Analysis 996.11. Liquefaction products of starch hydrolysis are not intact starch and should be considered as liquefaction products composed of soluble starch, higher sugars, and sugars. These can be separated from the analysis by methods such as washing with water and/or washing with ethanol. The difference between starch compositional results of CRA G-28 and AOAC 996.11 (e.g., the difference between measured total starch carbohydrates and starch content) results in the amount of soluble starch, higher sugars, and sugars, which should be considered starch liquefaction products instead of the sugars native to the mill streams.

The sugar content of the mill streams and the collected filtrate can be determined using a procedure derived from AACC Method 80-05 (e.g., using a HPLC system (e.g., Aminex HPX-87H ion exclusion column (Bio-Rad, Hercules, Calif.)) eluded with 0.01 N sulfuric acid mobile phase and having a refractive index detector). The sugar content generally is the sum of the amount of glucose, fructose, maltose and maltotriose sugars standardized against the column.

Sugar DP profile and quantitation in mill streams, liquefact, and extracted solubles of CPC can be performed using a procedure derived from AACC Method 80-05. The water extractables can be analyzed by, for example, precipitating proteins with sulfosalacylic acid, ion exchanging with anion and cation resin, filtering each liquid fraction through a filter (e.g., 0.45 micron Whatman syringe filter), and injecting the liquid into an HPLC system having a silver ion exchange column with water as the mobile phase and having a refractive index detector.

Analysis of the obtained information can be made as the sum of the eluded peaks less than the degree of glucose polymerization (DP) of 14 standardized against the column. The percentage of DP 1-4 sugars (calculated as the sum of the area under the curve of DP 1-4 sugars divided by the sum of the area under the curve of DP 1-14 sugars) is compared to the percentage of DP 5-13 sugars (calculated as the sum of the area under the curve of DP 5-13 sugars divided by the sum of the area under the curve of DP 1-14 sugars). Generally, CGM has predominantly DP 1-2 sugars with only trace amounts, if any, of DP 5-13. On the other hand, the CPC disclosed herein can contain about the same amount or a higher amount of DP 5-13 sugars than DP 1-4 sugars.

Total or crude lipid content can be determined using a protocol derived from AACC Methods 30-24, 30-20, 30-25, CRA G-11, or by AOAC 920.39 or 954.02. Methods using ether extraction, hexane extraction incorporating ball milling in a Spex mill, or acid-hydrolysis often result in different lipid values, with ether extraction generally resulting in the lowest lipid values and acid-hydrolysis generally resulting in the highest lipid values.

The water- or alcohol-absorption can be determined using absorption indexes and the water- or alcohol-solubility can be assessed using Osbourn's classification of protein extraction and solubilization scheme.

Organic acid content can be determined by HPLC using UV or RI detection.

Ash can be determined using a procedure derived from AACC Method 08-01 by wet-ashing of a sample at 560° C. or by AOAC 942.05.

Crude fiber can be determined by AOAC 962.09.

Phytate can be determined in a sample by extraction of phytic acid, which can be purified using different techniques and analyzed quantitatively by HPLC using conductivity.

Water activity (a_{w}) is the relative availability of water in a substance and is defined as the vapor pressure of water divided by that of pure water at the same temperature. For example, pure distilled water has a water activity of 1.0. As the temperature increases, a_{w} typically decreases, with the exception of some salt and sugar solutions. Water tends to migrate from high a_{w} substances to low a_{w} substances. In addition, higher a_{w} substances tend to support more microorganism growth. For example, bacteria usually require an a_{w} of at least 0.91 and fungi at least 0.7.

a_{w}≡p/p₀

where p is the vapor pressure of water in the substance, and p₀ is the vapor pressure of pure water at the same temperature.

### Methods of Making a Corn Protein Concentrate

The CPC described herein can be made by the process described in PCT Application No. PCT/US2005/003282, which is incorporated herein by reference in its entirety. Briefly, a CPC described herein is prepared by a process that includes contacting one or more corn protein-containing materials with one or more wet-mill streams and one or more carbohydrases.

The term “corn protein-containing material” refers to streams generated from the wet-milling process wherein greater than 2% of the solids are gluten and less than one quarter of the original kernel fiber and germ. The term “corn gluten” as used herein refers to water insoluble proteins derived from endosperm. Corn protein-containing material includes streams such as heavy gluten, gluten cake, starch wash overflow, and primary feed. One or more of these corn-protein-containing materials can be used in the process.

A wet-mill stream is a flowable stream formed by the wet-milling process. Exemplary wet-mill streams include corn steep liquor (CSL), which can be either heavy (evaporated CSL) or light (LSW), primary feed, any centrifuge or hydrocyclone overflow, a washing or dewatering filtrate, or mixtures thereof. Examples of centrifuge overflows include mill stream thickener overflow, primary overflow, clarifier overflow, starch wash overflow, or mixtures thereof. Examples of hydrocyclone overflows include starch wash overflow and millstream thickener. Examples of washing and dewatering streams include gluten filtrate and fiberwash filtrate. These streams are characterized in that they have at least trace amounts of protein and carbohydrates from corn.

The carbohydrases used can be any enzyme that can facilitate the degradation (such as by saccharification and/or liquefaction) of a complex carbohydrate to a water-soluble carbohydrate. For example, enzymes such as alpha-amylases, glucoamylases, dextrinases, pullulanases, hemicellulases, and cellulases or mixtures can be used. Alpha-amylase can be used to liquefy starch up to about a 40 dextrose equivalent (DE) sweetness measure. Mixtures of glucoamylase and pullulanase can be further used in a saccharification step after liquefaction to further degrade the starch polymers up to about 95-97DE, which contain greater than 90% of the total sugars (DP 1-14) with a composition of at least 90% sugars of DP 1-4.

In some embodiments, the methods involve liquefaction without saccharification. In these embodiments, the enzymes used will be those commonly used to hydrolyze starch molecules such as alpha-amylases. In some embodiments, the methods involve contacting the material with hemicelluloses and celluloses in combination with liquefaction and, optionally, saccharification. Malted grain and parts thereof may also be used as a source of enzyme.

In some embodiments, the protein content of the protein concentrate can be altered by using additional enzymes. For example, phytases and/or pectinases can be used to digest the phytate and/or the pectin, respectively, which will allow them to be separated from the protein concentrate. Use of phytases and pectinases may also result in a protein concentrate that is more digestible than a concentrate that has not been treated.

In some applications, elongated proteins are more desirable. Enzymes that join protein fragments such as polyphenoloxidases and/or transglutaminases can be used. These enzymes can be introduced simultaneously with the carbohydrases or they can be added in a separate step.

The corn protein-containing material(s), the wet mill-stream(s), and the carbohydrases can be placed in contact with each other using any method known in the art, such as by slurring, mixing, or blending. In some embodiments, methods can include a filtration step to remove unwanted or undesirable components.

The composition containing the carbohydrases, wet-mill stream(s), and corn protein-containing material(s) is incubated at a time and temperature sufficient to at least degrade the starch and/or other complex carbohydrates present in the corn protein-containing material and/or the wet-mill stream to the point where, upon separation of the aqueous stream containing water-soluble carbohydrates from the resulting corn protein concentrate, the aqueous stream has a higher concentration of water-soluble carbohydrates then the wet-mill stream had prior to contacting the carbohydrases.

Exemplary temperatures that can be used to incubate the mixture containing the carbohydrases, wet-mill stream(s), and corn protein-containing material(s) include from about 30 to about 250° F. (15-120° C.), and exemplary incubation times include from about ½ hours to about 40 hrs. The incubation temperature and time depend on the starting materials, enzymes, and the amount of enzymes used.

Separating the corn protein concentrate from the aqueous stream can be accomplished by any method known in the art. For example, filtration, centrifugation, coagulation, and combinations thereof can be used. It is also possible to increase the concentration of water-soluble carbohydrates in the aqueous stream by recycling or reusing the aqueous stream as one of the wet-mill streams used in the process.

The concentration of protein in the resulting protein concentrate can additionally be increased by rinsing the resulting concentrate with water and/or a wet-mill stream. The rinsing washes away residual carbohydrates and increases the protein concentration on a dry basis. Using this technique, the protein concentration can be increased by at least 2%, 5%, 7%, 10%, or 20% on a dry basis.

Yet another way of increasing the concentration of protein in the protein concentrate is to remove fats from the concentrate (i.e., defatting). Defatting can be accomplished using any method known in the art, for instance by using one or more solvents and/or enzymes to degrade the fats. Examples of solvents that can be used include hexane, isohexane, alcohols, and mixtures thereof. Examples of enzymes that can be used include lipases and the like. The fats can subsequently be separated from the protein concentrate using any method known in the art, for example filtration, floatation, and/or centrifugation.

Additionally, a protein concentrate can be decolorized by bleaching using either chemical and/or enzymatic methods. Enzymes that can be used to facilitate bleaching include those having lipoxygenase (LOX) activity or peroxidase activity. Chemicals that can be used alone or in combination with enzymes to facilitate bleaching include ozone, persulfate, and peroxides.

The filtration of the protein concentrate can be accomplished while the stream containing the protein is at temperatures of, for example, greater than 45° C., 50° C., 55° C., 60° C., 65° C., 80° C., or 100° C. This provides the advantage of being able to control microbial growth and mycotoxin concentration during the filtration process. The ability to use increased temperatures also allows enzyme activity to be modulated.

A CPC as described herein can be treated with an acid (e.g., in the presence of heat and/or pressure) and/or treated with one or more proteases. The one or more proteases can possess general hydrolyzing activity on peptide bonds or the one or more proteases may possess a more specific activity such as, for example, enhancing a processing functionality or generating a flavor. Hydrolyzed proteins optionally can be heated in the presence of a sugar (e.g., a reducing sugar such as glucose, fructose, corn syrup, or other compound) to produce a desirable smell and flavor. For example, a meaty flavor can be generated by heating the amino acid, valine, in the presence of a reducing sugar. Alternatively, proteins can be deaminated by such treatments to alter functionality such as water solubility.

A CPC can be deodorized by using deodorizing compound. A deodorizing compound can be added to CPC in a dry state or in a liquid or slurried state. Deodorizing compounds include, without limitation, cyclodextrins and alcohols. Examples of cyclodextrins include, without limitation, alpha-cyclodextrins, beta-cyclodextrins, and/or gamma-cyclodextrins. Cyclodextrins can be modified by substituting functional groups, such as hydroxypropylated, methylated, ethylated, or acethylated with various levels of substitution to yield different activities that result in distinct odors and solubility. The deodorizing compound can be introduced at any point during the process of making CPC. The deodorizing compound can be added to the finished CPC product or can be applied to the CPC packaging by mixing, blending, spraying, coating, or other methods obvious to those skilled in the arts. Although the amount of a deodorizing compound that is used in a CPC can vary, generally about 0.05% to 5% (wt/wt CPC on a dry basis) (e.g., about 0.25% to 2.5% (wt/wt CPC on a dry basis)) of a deodorizing compound will provide sufficient result.

### Feed Products

The CPC described herein can be used in a feed product for consumption by a companion animal. Companion animals include, without limitation, dogs, cats, birds, fish; potbelly pigs, rodents, horses, reptiles, and turtles. The feed product for consumption by a companion animal can be, for example, pet food or pet treats. Feed for a companion animal can be a dry feed (e.g., normal protein or high protein formulations) or a moist or wet feed. Feed for a companion animal can include sauces and dressings to apply to or pour over a pet food as, for example, a palatant. Feed for a companion animal can be formulated for weight loss or for a nutritional benefit. In certain embodiments, feed for a companion animal is produced by passing through a forming or cooking extruder for processing into the feed and the product exhibits desirable pellet and/or kibble functionality. Similarly, the food can be molded or formed.

The CPC described herein can be used in a feed product for consumption by other types of animals such as chickens, turkeys, game birds, cattle (e.g., dairy or beef), fish (e.g., farm- and coastal-raised carp, tilapia, salmon, walleye, trout, sea-bass or catfish), pigs, horses, sheep, wild birds, goats, llamas, buffalo, wildlife, exotic animals, zoo animals, amphibians, crustaceans, and mollusks. Amphibians include, for example, frogs. Crustaceans include, without limitation, shrimp, lobster, crabs, crayfish, and prawns. Mollusks included snails, clams, oysters, squid, octopus and mussels. Game birds include pheasants, grouse, partridges, ducks, geese, swans, doves, and pigeons. Animal feed containing CPC can be fed to an animal daily, weekly, or used as a feed supplement. Wildlife includes, for example, deer, antelope, squirrels, bears, and rabbits. Exotic animals include monkeys, snakes, and chinchillas. Zoo animals include monkeys, antelope, giraffe, elephants, cats, and bears.

The CPC described herein can be added to or applied on an existing animal feed, or can be used to replace other components of an animal feed such as bloodmeal or bonemeal. A typical inclusion level of CPC in a feed can vary from about 0.1% to about 100%, and generally is in the range of about 2% to about 40%. The effectiveness of an animal feed containing CPC can be determined, for example, using in vivo and duodenal collection techniques known in the art. See, for example, Beever et al., 1971, Brit. J. Nutr., 26:123-134.

A food product containing a CPC described herein can be evaluated for odor and flavor using a palatability trial. See, for example, characterization, evaluation and comparison methods based on a Two-Pan test, the Triangle-Comparison, or Hedonic Scale Evaluation methods of sensory evaluation (Powers, 1982, In Food Flavours, Part A, Introduction, Morton & Macleod, eds., Elseviers Scientific, Amsterdam, pp 121-168).

A CPC described herein provides a means for increasing the protein content of a feed.

In accordance with the present invention, there may be employed conventional chemistries, biochemistries and microbiological techniques within the skill of the art. Such techniques are explained fully in the literature. The invention will be further described in the following examples, which do not limit the scope of the invention described in the claims.

### EXAMPLES

### Example 1

### Evaluation of CPC

Four samples of corn gluten were received for functional property analyses and were labeled A, B, C and D. Samples A and B were CPC and Samples C and D were corn gluten meal.

Proximate analysis was performed for moisture, fat, protein and ash. The results of this analysis are shown in Table 1 and are reported on a dry weight basis (with the exception of moisture). The pH of the samples was determined by slurrying the protein samples in an equal mass of distilled water, allowing to equilibrate for 10 minutes, then measuring pH with a pH probe-meter. Proximate analysis was performed using Official Methods of the AOAC International. Moisture was determined by AOAC 935.29; fat by AOAC 954.02; protein by AOAC 990.03; and ash by AOAC 942.05.

TABLE 1

| | A | B | C | D |
|---|---|---|---|---|
| Moisture | 5.37 | 6.16 | 5.91 | 4.69 |
| Protein | 78.14 | 81.05 | 68.32 | 67.31 |
| Fat | 8.95 | 5.54 | 8.06 | 6.24 |
| fat:protein ratio | 0.115 | 0.068 | 0.118 | 0.093 |
| Ash | 0.95 | 1.54 | 1.27 | 1.29 |
| ash:protein ratio | 0.012 | 0.019 | 0.019 | 0.019 |
| pH | 5.6 | 5.5 | 3.9 | 4.1 |

Solubility of CPC was tested in water and ethanol solutions. Solutions were prepared with enough CPC to produce a concentration equivalent of 5% protein suspended in different solvents to examine solubility. Water, water:denatured ethanol (in a 1:1 ratio), or denatured ethanol (97%) were used as the solvents. Protein analyses were done on the suspensions using the Bio-Rad Protein Assay. One ml aliquots of each suspension were centrifuged in an Eppendorf microcentrifuge for 10 minutes and the supernatants analyzed for dissolved protein using the Bio-Rad Protein Assay. Protein solubility indices were calculated as follows:

[protein content of supernatant/protein content of suspension]×100.

Table 2 shows that all four samples had relatively low solubility in water compared to, for example, globular proteins such as egg and purified soybean protein isolate.

Results indicated that the solubility of samples A and B were substantially increased in the water:ethanol solvent. The supernatant of sample D, however, tested at 2.9% and 2.1%, indicating a significant increase in solubility.

While there was some dissolved protein detected in ethanol-suspended samples A and B, the supernatants of samples C and D in the ethanol tested at 0.05% and 0.0%, respectively, indicating very low solubility for samples C and D.

The solubility in water was low for all four samples, although the presence of ethanol seemed to improve the solubility. In any event, a water: ethanol solvent appears to be a suitable solvent for samples A and B (CPC).

TABLE 2

| | A | B | C | D |
|---|---|---|---|---|
| Water | 2.03 | 1.96 | 5.04 | 3.01 |
| 1:1 Water:EtOH | 13.82 | 21.57 | 6.25 | — |
| EtOH | 16.35 | 9.39 | — | 0.0 |

The effect of pH on solubility of samples A and B was examined. The pHs of the aqueous suspensions prepared as described above for samples A and B were adjusted to each of the pHs shown below in Table 3 (i.e., 2, 4, 5.5, 7, 9 and 11) and an aliquot was drawn. The aliquot was centrifuged and analyzed for protein concentration, i.e., indicating relative solubility of the proteins at each pH. Results are shown in Table 3. There was a very small increase in solubility at alkaline pH for sample A, and little to no increase was detected for sample B.

TABLE 3

| pH | A | B |
|---|---|---|
| 2 | 0.250 | 0.075 |
| 4 | 0.150 | (below detection limits) |
| 5.5 | 0.112 | (below detection limits) |
| 7 | 1.193 | 0.062 |
| 9 | 0.612 | (below detection limits) |
| 11 | 1.325 | 0.168 |

More than one pH optimum for solubility was observed, but because these samples contain more than one type of protein, it is possible that the different proteins are solubilizing at different pH's.

### Example 2

### Evaluation of CPC

Three samples of CPC and three samples of corn gluten meal were sent to external laboratories for proximate analysis. Proximate analysis was performed using Official Methods of the AOAC International. Moisture was determined by AOAC 935.29; fat by AOAC 954.02 (acid hydrolysis) and AOAC 920.39 (ether extract); protein by AOAC 990.03; ash by AOAC 942.05, and total starch and sugars were determined by AOAC 996.11. Total starch was determined by official analytical method of the Corn Refiners Association, CRA G-28. Sugars are determined by the difference between total starch and sugars minus total starch. Sugars includes starch liquefaction products, higher sugars, and sugars, including those native to the wet milling streams captured in the CPC. Results of this analysis are shown in Table 4 and are reported on a dry weight basis (with the exception of moisture). The ratio of fat or ash to protein is calculated by the fat or ash content divided by the protein content on a dry compositional basis.

TABLE 4
Compositional Analysis of Corn Protein Concentrate
compared to Corn Gluten Meal

| | CPC 1 | CPC 2 | CPC 3 | CGM 1 | CGM 2 | CGM 3 |
|---|---|---|---|---|---|---|
| Moisture | 7.3 | 8.2 | 10.6 | 8.6 | 9.6 | 11.0 |
| Protein | 81.5 | 82.2 | 81.5 | 70.3 | 70.6 | 70.7 |
| Fat (Ether | 2.42 | 2.56 | 2.44 | 1.25 | 1.11 | 1.39 |
| extract) | | | | | | |
| EE fat:protein | 0.030 | 0.031 | 0.030 | 0.012 | 0.016 | 0.020 |
| ratio | | | | | | |
| Fat (acid | 5.2 | 4.8 | 5.7 | 4.4 | 4.1 | 3.7 |
| hydrolysis) | | | | | | |
| AH Fat:protein | 0.064 | 0.058 | 0.070 | 0.063 | 0.058 | 0.052 |
| ratio | | | | | | |
| Ash | 1.5 | 1.1 | 1.3 | 1.2 | 1.2 | 1.2 |
| ash:protein | 0.018 | 0.013 | 0.016 | 0.017 | 0.017 | 0.017 |
| ratio | | | | | | |
| Total starch | 0.4 | 0.9 | 0.7 | 16.0 | 16.6 | 18.5 |
| Total starch | 5.4 | 5.7 | 6.6 | 18.5 | 19.2 | 20.5 |
| & sugars | | | | | | |
| Sugars | 5.0 | 5.8 | 5.9 | 2.5 | 2.6 | 2.0 |
| Magnesium | 0.07 | 0.06 | 0.05 | 0.05 | 0.04 | 0.07 |
| pH | 5.6 | 5.5 | 5.5 | 4.4 | 4.6 | 4.3 |

CPC has a higher quantity of ether-extractable fats in comparison to the CGM. However, the total fat content of the samples as determined by acid hydrolysis is similar between CGM and CPC on a protein unit (ratio) basis. Although not bound by any particular mechanism, the process of making the CPC as described herein may release the fat so as to make it more available for extraction with ether. This higher level of “free” fats result in different functional and nutritional properties (e.g., extrusion processing functionality and digestibility) of CGC as compared to CGM. In addition, the greater accessibility of the fats and oils to solvents such as ether and hexane make the CPC material more easily defatted. The quantity of intact starch is decreased from 16.0-18.5% in CGM to 0.4-0.9% in CPC. The quantity of sugars and starch liquefact (higher sugars) is increased from 2.0-2.6% in CGM to about 5.0-5.9% in CPC (of the dry weight composition). The magnesium content of CPC is unexpectedly similar to the CGM and was not concentrated due to the removal of starch (e.g., the magnesium content is not significantly different on a mass basis and is lower on a protein basis than the CGM). As shown in Example 1, the pH of CGC is higher, at about 5.5-5.6, than CGM, at 3.9-4.6, and CGC has a more consistent pH for manufacturing benefits of pH control and cost of adjustment. When compared to CGM, CPC was found to contain fewer wet milling smells and odors; a panelist of judges and those familiar with the wet milling process found that CPC contained fewer smells commonly associated with the wet milling process in comparison to CGM and had a smell more similar to corn.

### Example 3

### Extraction of Fat from CPC

The concentration of protein in the CPC was increased through removal of the fats (i.e., defatting). One method of defatting is performed by passing hexane through a bed of CPC in an industrial solvent extractor. The hexane is applied in a countercurrent flow pattern to the movement of the newest to most fat extracted CPC. The CPC is desolventized after centrifuging or filtering using a desolventizing-toaster apparatus commonly found in oilseed and germ extraction plants. Examples of other solvents that can be used include hexane, isohexane, alcohols, and mixtures thereof. Alternatively, the solvent can be applied to the CPC and separated in a reflux or membrane separation devices. The solvent can be recovered through distillation to separate the oil from the solvent and the reclaimed solvent can be reused in the extraction process.

### Example 4

### Pet Feed and Animal Feed Formulations

Pet feed and animal feed formulations were prepared as shown in Tables 5, 7, and 9. Each pet feed or animal feed underwent nutritional analysis and formulation with CPC using a proprietary formulation and composition computer software program. Similar programs are commercially available. Exemplary formulations are shown in Tables 6, 8, and 10.

TABLE 5
Cat feed

| | BASE | CPC | CPC |
|---|---|---|---|
| | CGM (60% | (75% | (80% |
| | protein) % | protein) % | protein) % |
| WHEAT | 20.00 | 20.00 | 20.00 |
| POULTRY BY-PRODUCT (PBP) | 27.90 | 28.40 | 28.40 |
| SALT | 0.64 | 0.60 | 0.61 |
| FAT | 10.00 | 10.00 | 10.00 |
| POTASSIUM CH 50 | 0.53 | 0.54 | 0.54 |
| FOLIC ACID USP | 0.00 | 0.00 | 0.00 |
| SOYBEAN OIL | 2.00 | 2.50 | 2.50 |
| CORN GLUTEN MEAL (CGM) | 20.00 | — | — |
| CHOLINE CHLORIDE 60 | 0.08 | 0.08 | 0.08 |
| PHOS ACID | 1.00 | 1.00 | 1.00 |
| LYSINE | 0.15 | 0.13 | 0.13 |
| WHEAT RED DOG | 6.81 | 5.01 | 5.01 |
| BREWERS RICE | 10.00 | 10.00 | 10.00 |
| TAURINE | 0.05 | 0.05 | 0.05 |
| PET FOOD VIT | 0.28 | 0.68 | 0.68 |
| PET FOOD PMX | 0.58 | 1.00 | 1.00 |
| CORN PROTEIN | — | 20.00 | 20.00 |
| CONCENTRATE (CPC) | | | |
| | 100.00 | 100.00 | 100.00 |

TABLE 6
Analysis of Cat Feed

| | BASE | CPC | CPC |
|---|---|---|---|
| | CGM (60% | (75% | (80% |
| | protein) % | protein) % | protein) % |
| PROTEIN | 34.00 | 36.26 | 37.25 |
| FAT | 16.00 | 16.95 | 16.95 |
| ASH | 7.00 | 7.00 | 7.00 |
| FIBER | 1.22 | 1.12 | 1.12 |
| CALCIUM | 1.28 | 1.30 | 1.30 |
| PHOSPHORUS | 1.14 | 1.14 | 1.14 |
| ADJ TOTAL STARCH | 22.74 | 20.02 | 19.22 |

TABLE 7
Aqua Diet

| | BASE | CPC | CPC |
|---|---|---|---|
| | CGM (60% | (75% | (80% |
| | protein) % | protein) % | protein) % |
| CORN | — | — | — |
| WHEAT | 12.00 | 12.29 | 12.69 |
| MIDDS | 15.00 | 15.00 | 15.00 |
| RICE BRAN-HI FAT | — | — | — |
| FEATHER MEAL | 14.00 | 14.00 | 14.00 |
| SBM | — | — | — |
| CALCIUM CARB | 2.48 | 2.99 | 2.99 |
| CORN GLUTEN MEAL (CGM) | 4.00 | 0.80 | 0.40 |
| FISH SOLUABLES ML | 65.00 | 65.00 | 65.00 |
| CHICKEN MEAL | 18.54 | 17.00 | 17.00 |
| FISH OIL | 0.80 | 0.80 | 0.80 |
| MOISTURE CHANGE | (31.82) | (31.87) | (31.88) |
| CORN PROTEIN | — | 4.00 | 4.00 |
| CONCENTRATE (CPC) | | | |
| | 100.00 | 100.00 | 100.00 |

TABLE 8
Analysis of Aqua Diet

| | BASE | | |
|---|---|---|---|
| | CGM (60% | CPC | CPC |
| | protein) % | (75% protein) % | (80% protein) % |
| PROTEIN | 50.00 | 50.00 | 50.00 |
| FAT | 10.92 | 10.83 | 10.83 |
| ASH | 11.59 | 11.88 | 11.88 |
| FIBER | 2.28 | 2.27 | 2.28 |
| CALCIUM | 1.43 | 1.60 | 1.60 |
| PHOSPHORUS | 1.02 | 1.00 | 1.00 |
| ADJ TOTAL | 8.87 | 8.73 | 8.69 |
| STARCH | | | |

TABLE 9
Calf Diet

| | BASE | CPC | CPC |
|---|---|---|---|
| | CGM (60% | (75% | (80% |
| | protein) % | protein) % | protein) % |
| CORN | 9.15 | 9.94 | 10.98 |
| HOMINY | — | — | — |
| MIDDS | 32.00 | 32.00 | 32.00 |
| SBM | 3.00 | 3.00 | 3.00 |
| SALT | 0.93 | 0.91 | 0.90 |
| MOLASSES | 3.00 | 3.00 | 3.00 |
| POULTRY FAT | 0.34 | — | — |
| CAL CARB | 1.58 | 1.56 | 1.55 |
| DICAL PHOS | 0.09 | 0.11 | 0.13 |
| BEEF BLOOD MEAL | — | — | — |
| TRACE MINERAL | 0.03 | 0.03 | 0.03 |
| POTASSIUM CH 50 | 0.16 | 0.16 | 0.16 |
| CORN GERM | — | — | — |
| MAG OX 54 | 0.22 | 0.22 | 0.22 |
| CORN GLUTEN MEAL (CGM) | 5.93 | 1.72 | 1.75 |
| COPPER SULFATE | 0.00 | 0.00 | 0.00 |
| RED DOG | 43.14 | 41.79 | 41.01 |
| SELENIUM | 0.13 | 0.13 | 0.13 |
| ORGANIC TRACE MINERAL | 0.10 | 0.10 | 0.10 |
| DAIRY VITAMIN PREMIX | 0.21 | 0.21 | 0.21 |
| CORN PROTEIN | — | 5.13 | 4.81 |
| CONCENTRATE (CPC) | | | |
| | 100.00 | 100.00 | 100.00 |

TABLE 10
Analysis of Calf Diet

| | BASE | CPC | CPC |
|---|---|---|---|
| | CGM (60% | (75% | (80% |
| | protein) % | protein) % | protein) % |
| PROTEIN | 18.87 | 18.96 | 18.91 |
| FAT | 3.59 | 3.44 | 3.44 |
| ASH | 6.66 | 6.66 | 6.66 |
| FIBER | 5.21 | 5.16 | 5.14 |
| CALCIUM | 0.79 | 0.79 | 0.79 |
| PHOSPHORUS | 0.70 | 0.70 | 0.70 |
| TOTAL STARCH | 25.61 | 25.96 | 26.18 |

Formulating the feeds and rations described herein with CPC provided varying degrees of benefit primarily based on the amount of space in the ration to provide a balanced nutritional profile for the animal, pet, bird or aqua species considered. CPC is a concentrated source of vegetable protein with a very low concentration of starch. Use of CPC in the formulation provided a clear benefit of allowing more flexibility of including other ingredients within the ration due to the higher concentration of protein and, sometimes, oil as provided by the CPC product as compared to CGM. Similar benefits are likely to be observed when comparing CPC to other concentrated protein sources such as soybean meal, other legume meals, chicken byproduct meal, fishmeal, and bloodmeal. CPC provides a good source of methionine and can be incorporated into calf diets to replace commonly used sources such as bloodmeal. CPC is slowly digested in the rumen and has rumen by-pass properties

### Example 5

### Aquafeed

As shown in Table 11, CPC can be used in the formulation of a low starch, high protein aquafeed for carnivorous fish. Examples of carnivorous fish include sea bass, salmon, and/or trout. The aquafeed is formulated with CPC using a proprietary formulation and a commercially available composition computer software program. The analysis of the formulation is shown in Table 12. The formulation generally contains less than 10% starch (e.g., less than 8% or 5% starch), greater than 10% fat (e.g., greater than 15% fat), and greater than 45% protein (e.g., greater than 50% protein).

The low starch content reduces fecal material bulk, increases pond clarity, reduces disease potential, reduces odor and algae problems, and increases the amount of digestible energy in the formulation. Rate of gain is higher for the low starch aquafeed than a typical diet, for example, a diet adopted from the Fish NRC 1993. Liquefied starch carbohydrates, higher sugars, and sugars contributed to the diet by the CPC are more digestible than the intact starch found in current aquafeeds. Total starch can be determined by official analytical method of the Corn Refiners Association, CRA G-28 or another suitable analytical method.

In addition to the nutritional benefits, CPC's functional properties allows binding of the ingredients in the formulation and allows the product to expand during the extrusion process such that aquafeed pellets can be manufactured to have specific floating and sinking characteristics not normally achievable using a typical low starch formulation. The oil binding characteristics of CPC allow higher oil inclusion in the diet. The low starch, high CPC formulation also had low water uptake rates that allowed longer feeding times and less waste and water pollution.

TABLE 11
Formulation of Aquafeed Diet with CPC Inclusion

| Ingredient | % Inclusion |
|---|---|
| Fish Meal | 25.000 |
| Corn Protein Concentrate | 20.080 |
| Wheat, middlings | 12.200 |
| Blood Meal | 10.000 |
| Fish Oil | 9.000 |
| Meat and Bone Meal | 8.106 |
| Whey, dehydrated | 5.000 |
| Wheat germ | 5.000 |
| Chicken By-Product Meal | 3.339 |
| Vitamin D 500 | 1.000 |
| Salt | 0.750 |
| Potassium Chloride | 0.218 |
| Vitamin Premix C | 0.188 |
| Trace Mineral Premix | 0.100 |
| Stay-C 35, Vitaman Premix | 0.014 |
| Kelp, dehydrated seaweed | 0.006 |

TABLE 12
Analysis of Aquafeed Diet

| Nutrient | | Composition |
|---|---|---|
| Dry Matter | % | 92.06 |
| Crude Protein | % | 50.03 |
| Methionine | % | 0.92 |
| Crude Fat | % | 14.01 |
| Linoleic acid | % | 1.37 |
| Ash | % | 10.27 |
| Calcium | % | 2.28 |
| Phosphorous | % | 1.47 |
| Potassium | % | 0.80 |
| Copper | mg/kg | 15.84 |
| Zinc | mg/kg | 184.72 |
| Vitamin A | IU/kg | 11278.82 |
| Vitamin D | IU/kg | 6125.30 |
| Choline | mg/kg | 1458.39 |
| Tryptophan | % | 0.40 |
| Crude Fiber | % | 2.57 |
| Starch | % | 7.60 |
| ME | kcal/kg | 3483.79 |

### Example 6

### Pet Food

A cat food diet was prepared with the formulation as shown in Table 13. The formulation underwent nutritional analysis and formulation with CPC using a proprietary formulation and a commercially available composition computer software program. The target diet was about 34.5% Protein, 15% Fat, <8% Ash, and 3700 kcal/kg Metabolizable Energy (ME). CPC inclusion levels were varied against corn gluten meal (CGM). All formula's included chicken by-product meal (CBPM) at varying levels and also a diet with 0% corn protein (e.g., from CPC or CGM) that was formulated with CBPM as the primary protein source.

The ingredients were blended and the food manufacture. The ingredients were extruded through a Wenger X-20 single screw extruder operated at 300 rpm screw speed with about 33.2-33.6 kg/hr added steam and about 13.1-15.4 kg/hr added water added in the preconditioner and 7.8-11.8 kg/hr water added into the extruder (CPC required less water than CGM and CBPM), a head pressure of 400-450 psi, and a barrel temperatures of about 98-100° C. The extruded kibbles were dried in a Wenger fluidized bed dryer. Kibbles were coated with 6% chicken fat after cooling.

Palatability, digestibility, and stool quality testing were performed by a laboratory whose kennel facility was registered with the USDA under the Animal Welfare Act. Palatability was tested using a two pan test. Each diet was offered at 100 grams for 4 hr per cat. Testing was done with 20 cats over 2 days. Food intake was recorded daily. Results are shown in Table 14. Digestibility analysis on the diets was performed as defined by Method 1 of the Association of American Feed Control Officials (AAFCO). Results are shown in Table 15. Stool collection was taken 3 times a day. Stool quality was tested during a feeding study of which six animals were fed diet for 5 days. Stools were collected and rated for quality on a scale of 1 to 5 (with 1=watery diarrhea, 1.5=diarrhea, 2=moist no form, 2.5=moist some form, 3=moist formed, 3.5=well formed & sticky, 4=well formed, 4.5=hard & dry, 5=hard, dry, crumbly). Results are shown in Table 16.

TABLE 13
Cat Diet Formulation

| | % Ingredient Inclusion in Different Diets | | | | |
|---|---|---|---|---|---|
| | CGM, | CPC, | CPC, | CPC, | CBPM |
| Ingredients: | 25% | 20% | 35% | 7% | only 42% |
| Corn Protein Concentrate | 0 | 20 | 35 | 7 | 0 |
| Corn Gluten Meal | 25 | 0 | 0 | 0 | 0 |
| Chicken By Product Meal | 20 | 20 | 14.2 | 34.3 | 42.7 |
| Wheat | 10 | 10 | 10 | 10 | 10 |
| Corn | 10 | 10 | 10 | 10 | 10 |
| Brewers Rice | 17 | 22 | 12.7 | 20.8 | 19.4 |
| Chicken meat, HPPC | 5 | 5 | 5 | 5 | 5 |
| Animal Fat (6% coating) | 10 | 10 | 10 | 10 | 10 |
| Taurine, Yeast, Vitamins, | 2.5 | 2.5 | 2.5 | 2.5 | 2.5 |
| & Mineral premixes | | | | | |
| Digest | 0.5 | 0.5 | 0.5 | 0.5 | 0.5 |

TABLE 14
Palatability Assessment of CPC Inclusion in comparison to CGM and
CBPM in Cat Diets

| | | | Consumption | Total | Individual |
|---|---|---|---|---|---|
| | Amount | Intake | Preference | First Choice | First Choice |
| Diet/Formulation | Consumed (g) | Ratio (%) | (# cats) | (# observations) | (# cats) |
| CPC, 20% vs. | 1417 | 60.7 | 2 | 26 | 6 |
| CGM, 25% | 922 | 39.3 | 0 | 14 | 0 |
| No preference | — | — | 18 | — | 14 |
| CPC, 35% vs. | 1314 | 64.1 | 2 | 16 | 6 |
| CPC, 20% | 684 | 35.9 | 0 | 24 | 2 |
| No preference | — | — | 18 | — | 12 |
| CPC, 20% vs. | 1202 | 61.0 | 1 | 31 | 12 |
| CBPM, 42% | 827 | 39.0 | 0 | 9 | 1 |
| No preference | — | — | 19 | — | 7 |

TABLE 15
Percent Digestibility of Cat Diets in Feeding Trials

| | | | | Dry Matter |
|---|---|---|---|---|
| | Protein (%) | Fat (%) | Caloric (%) | (%) |
| CGM, 25% | 88.9 | 90.8 | 90.2 | 86.2 |
| CPC, 20% | 86.5 | 89.5 | 89.5 | 85.4 |
| CPC, 35% | 87.3 | 88.8 | 88.4 | 84.8 |
| CBPM, 42% | 83.3 | 92.2 | 88.7 | 81.9 |

TABLE 16
Stool Quality Rating of Fed Cat Diets

| | Stool Quality |
|---|---|
| Diet | Rating (1-5) |
| CGM, 25% | 3.72 |
| CPC, 20% | 3.68 |
| CBPM, 42% | 3.56 |

The CPC formulations required less water in the extruder barrel than did the CGM or CBPM formulations. The CPC formulations required 7.4 and 8.3 Kg/hr water addition for the 20% and 35% CPC inclusion levels, respectively, while the CGM formulated diet required 11.5 Kg/hr and the CBPM formulation required 11.8 Kg/hr to achieve similar expansion and extruder functionality. The extruded kibbles from the CPC formulation had 384 g/L bulk density while the CGM had 450 g/L bulk density and the CBPM had 460 g/L bulk density. The CPC inclusion in the diet resulted in extrusion functionality that allowed more expansion with less water addition resulting in a lower bulk density. Lower water addition had the benefit of less drying costs post-extrusion and potentially greater nutrient conservation due to less drying requirements.

The kibbles of the different formulated diets varied in appearance. The kibbles produced from the CPC diet formulations were lighter in color with more yellow hues compared to the CGM diet formulation, which had an orange hue and the CBPM diet formulation, which were brown in color. It is understood by those of skill in the art that yellow color can be more easily altered for appearance preference than can orange or red hues. CPC can be included in various amounts to lighten the appearance of kibbles. The kibbles from the CPC also had a smoother surface and more regularity in their shape than kibbles made from CGM or CBPM formulations. It is known by those in this art that a smoother surface is desirable for bite preference for cats as well as other animals. Regularity of shape also is important for optimal visual appearance. In addition, a lower quantity of residual CPC particles was present on the surface or internally within the kibbles as compared to CGM. CPC had the benefit of better mixing with the other ingredients and better dispersion within the kibble. As the CPC did not have a significant amount of particles on the surface of the kibbles as compared to CGM, less fines were generated during drying or packaging and the surface of the kibble had a more uniform, premium appearance. It is understood by those in the art that fines are an undesirable economic processing loss.

Palatability testing results shown in Table 14 demonstrate that cats unexpectedly preferred diets with CPC inclusion compared to CGM or CBPM diets, and higher inclusion of CCP (35% vs. 20%) was preferred. Also unexpectedly, the cats preferred the corn protein inclusion diet over the high inclusion of CBPM, e.g. animal protein. CPC-based diets were consumed in greater amounts and at higher intake ratios than diets without inclusion of CPC. The cats preferred the diets formulated with CPC over CGM or CBPM as evidenced by the higher consumption and greater first choice preferences when diets were offered simultaneously. When CPC was included in the diet at a higher level of 35% and compared to 20% inclusion, the 35% inclusion level diet was consumed in greater amounts, had a higher consumption preference, and also had a higher individual first choice preference among the cats. CPC had a positive impact on palatability and higher inclusion levels were preferred.

As shown in Table 15, unexpectedly, the corn protein-supplemented diets had higher protein and dry matter digestibility than the CBPM (animal protein)-based diet. These results were in contrast to most published literature indicating moderate digestibility of corn protein ingredients. CPC was included up to 35% without a negative effect on digestibility or manufacturing quality. As shown in Table 16, the stool quality ratings were slightly firmer with corn protein inclusion in the diets and CPC had the firmest stools that were within a desirable rating. Similar functionality, palatability, digestibility, stool quality, and other factors beneficial to the animal are expected when CPC is included in the food for other species of companion animals as well as for other animals.

### Example 7

### Pet Food Manufacturing Benefits

A dog food diet was prepared with the formulation as shown in Table 17. The formulation underwent nutritional analysis and formulation with CPC using a proprietary formulation and a commercially available composition computer software program. The target diet was about 28% Protein, 17% Fat, <8% Ash, 3700 ME kcal/kg. CPC inclusion levels were varied against corn gluten meal (CGM). A diet based on animal protein only (chicken by-product meal, CBPM) was also prepared. All formula's included CBPM at varying levels.

The ingredients were blended and the food manufactured. The ingredients were extruded through a Wenger X-20 single screw extruder operated at 295-300 rpm screw speed with about 30.0-31.2 kg/hr added steam and about 7.8-11.8 kg/hr added water added in the preconditioner and 5.6-7.0 kg/hr water added into the extruder barrel (CPC required less water addition to achieve acceptable process functionality than did CGM and CBPM), a head pressure of 400 psi, and a zone 2 barrel temperatures of about 80-82° C. The extrusion parameters are shown in Table 18. The extruded kibbles were dried in a Wenger fluidized bed dryer. The kibbles were rated for color, comparative smoothness (1=rough to 5=smooth), extruded kibble texture, and the total number of CGM or CPC particulate fines on the exterior of 10 kibbles was recorded. Kibbles were coated with 13-14.9% chicken fat.

TABLE 17
Dog Diet Formulations

| | % Ingredient Inclusion in Different Diets | | | | |
|---|---|---|---|---|---|
| | CGM, | CPC, | CPC, | CPC, | CBPM |
| Ingredients: | 20% | 16% | 25% | 4.5% | only, 31% |
| Concentrated Corn Protein | 0 | 16 | 25 | 4.5 | 0 |
| Corn Gluten Meal | 20 | 0 | 0 | 0 | 0 |
| Chicken By Product Meal | 15 | 15 | 0.6 | 25 | 31 |
| Wheat | 10 | 10 | 10 | 10 | 10 |
| Corn | 10 | 10 | 10 | 10 | 10 |
| Brewers Rice | 24.1 | 28 | 29.3 | 29.6 | 28.1 |
| Chicken meat | 4 | 4 | 4 | 4 | 4 |
| Animal Fat (chicken) | 13 | 13.1 | 14.9 | 13 | 13 |
| Digest | 0.5 | 0.5 | 0.5 | 0.5 | 0.5 |

TABLE 18
Dog Diet Extrusion Parameters and Power Required to Extrude Diet
(expressed as % motor load)

| | Diet Formulation/% Inclusion | | | |
|---|---|---|---|---|
| | | | | CBPM |
| | CGM, | CPC, | CPC, | only, |
| Extruder Parameter: | 20% | 16% | 25% | 31% |
| Water Added in Preconditioner (Kg/hr) | 11.1 | 10.1 | 9.1 | 14.6 |
| Steam Added in Preconditioner (Kg/hr) | 30.1 | 31.0 | 30.5 | 31.4 |
| Water Added in Barrel (Kg/hr) | 6.0 | 6.4 | 5.6 | 7.0 |
| Extruder Motor Load (%) | 28 | 30 | 39 | 24 |

TABLE 19
Physical Characteristics of Dog Diet Extruded Kibbles

| | Extruded Kibble from Diet Formulation: | | | |
|---|---|---|---|---|
| | CGM, | CPC, | CPC, | |
| Kibble Characteristic: | 20% | 16% | 25% | CBPM, 31% |
| Kibble Color | Orange | Yellow | Light | Tan/Brown |
| | | | Yellow | |
| Kibble Cohesion | Cohesive | Doughy | Doughy | Crumbly |
| Surface Smoothness (1-5) | 2 | 4 | 5 | 1 |
| Surface Gluten | 12 | 2 | 3 | N/A |
| Particulates (#/10 kibbles) | | | | |
| Bulk Density (g/L) | 344 | 328 | 300 | 531 |

The kibbles produced from the formulations including CPC had a smoother surface texture and the internal cell structure was more uniform and had doughy-stretchable characteristics, indicating a gluten-like functionality. Table 19 also shows that there was very little presence of gluten particles on the surface of the kibbles produced with CPC (2-3 particles per 10 kibbles) as compared to the CGM (12 particles per 10 kibbles). Better incorporation of corn gluten protein particles is evident in the slightly greater motor load required to extrude the CPC formulated diets. The lack of particles gave a more uniform color and quality appearance.

CPC-containing kibbles were lighter in color and more yellow in color with less of the orange hues found in the CGM kibbles. The kibbles from the CPC formulations were comparatively more uniform in shape and had greater expansion under similar extrusion conditions. Greater expansion is evident as lower bulk density of the kibbles (see Table 19). The greater expansion with CPC inclusion was accomplished with less water use in the extrusion process. More expansion was also achieved with lower water usage as in the cat diets with CPC in Example 7. Lower water use saves drying costs, as the kibbles are dried from approximately 40% moisture to less than 10% (see Table 19). The kibbles were fed to dogs and the CPC kibbles had similar digestibility for protein, fat and dry matter as the CGM and chicken by-product meal kibbles as tested by similar procedures as those outlined in Example 6. The results are shown in Table 20.

TABLE 20
Digestibility of Dog Diets in Feeding Trials

| | Protein (%) | Fat (%) | Caloric (%) | Dry Matter (%) |
|---|---|---|---|---|
| CGM, 20% | 88.6 | 95 | 92.7 | 88.6 |
| CPC, 16% | 87.7 | 94 | 91.4 | 86.7 |
| CPC, 25% | 89.1 | 95.9 | 92.7 | 88.3 |
| CBPM, 42% | 81.6 | 94.6 | 90.2 | 84 |

### Example 8

### Satiety Agent

As shown in Example 7, CPC was formulated in dog food diets at 4.5, 16, and 25% inclusion level in the formulation, and also formulated into cat food diets at 7, 20, and 35% inclusion level as shown in Example 6. Feeding studies indicate that animals fed the CPC diets eat less amounts of food over longer periods of time. Higher inclusion levels of CPC and higher protein diets provide a satiety effect on the animals. The animals maintained a more ideal weight when fed the high protein and high inclusion level of CPC diet. One effect of feeding higher levels of CPC realized even though such an effect is theorized with the presence of decreased leptin AUC (area under the curve) and increased ghrelin AUC hormones in the animals (Weigle et al., Am J Clin Nutr. 2005 July; 82 (1):1-2). The effect may also be due to the amino acid profile of CPC in comparison to animal-derived proteins.

### Example 9

### Caloric Density Management

CPC was included in pet food diets as shown in Examples 6 and 7. Inclusion of CPC in a dog and cat food diet resulted in a greater expansion and lower bulk density of pellets as compared to pet food having CGM at similar inclusion level (on a protein basis) or an animal protein based diet formulation. The ability to achieve greater expansion without the need to make other alterations to the formulation or increase the energy and water in the manufacturing process resulted in a diet of lower bulk density that contained fewer calories per unit volume. CPC is a unique source of concentrated protein for a pet food that can be incorporated into a food for its high protein content but contributes only a low amount of fat to the food. The pet owner receives the benefit of visually feeding larger volumes of material while the pet maintains a more ideal weight due to not being overfed calories. The manufacturer has the benefit of a choice of ingredients that provides a perceived wholesome diet while keeping a desirable order of predominance on the label. A caloric management benefit is achieved.

### Example 10

### Nutritional Supplement

CPC can be included in a single serving-style nutrition bar (e.g., energy bar) or a treat. The CPC can be included as an ingredient in the formulation at a rate of 15% inclusion as a source of protein and/or to enhance the texture of the bar. Generally, a nutritional bar contains greater than 20% protein content. In addition, CPC oil binding properties can be used to increase the oil and overall energy content of the bar. Example 11 provides one illustration how to incorporate oil into such a bar, treat, or kibble.

### Example 11

### Extrusion Properties and Oil Binding

CPC was tested in a pilot scale Buhler twin screw extruder with moderate and high shear screw (flite) setups. The extruder was operated at 450 rpm. Water and feed rates were varied to control the work put into the CPC and the expansion ratio. Extrusion parameters used on CPC alone and with mixtures of other ingredients is shown in Table 21. Texture analysis of the extrudate was performed on a TA Instruments Texture Analyzer (Model TX2i) using a Back Extrusion Cell and a 45 mm diameter probe with a compressive deformation rate of 1 mm/sec and a 50 g trigger force. The probe was allowed to compress the pellets 3 mm, then the compression stroke was repeated and the force in grams of the second compression was recorded.

CPC was tested in a pilot scale Buhler twin screw extruder with moderate and high shear screw (flite) setups. The extruder was operated at 450 rpm. Water and feed rates were varied to control the work put into the CPC and the expansion ratio. Extrusion parameters used on CPC alone and with mixtures of other ingredients is shown in Table 21. Texture analysis of extrudate was performed on a TA Instruments Texture Analyzer model TX2i using a Back Extrusion Cell and a 45 mm diameter probe with a compressive deformation rate of 1 mm/sec and a 50 g trigger force. The probe was allowed to compress the pellets 3 mm, then the compression stroke was repeated and the force in grams of the 2^{nd} compression was recorded.

TABLE 21
Twin Screw Extrusion Parameters of Extruding CPC Alone and with
Other Ingredients

| | | | | Die | Die |
|---|---|---|---|---|---|
| | Feed | Water | Energy | Temperature | Pressure |
| | (kg/hr) | (kg/hr) | (Watt * Hr/kg) | (° C.) | (Bar) |
| 100% CPC | 60 | 8.5 | 142 | 151 | 37 |
| 100% CPC | 35 | 8.0 | 134 | 132 | 26 |
| 90% CPC + 10% Tapioca Starch | 60 | 9.0 | 142 | 147 | 34 |
| 70% CPC + 30% Soybean Protein | 60 | 14.0 | 129 | 147 | 39 |
| Isolate | | | | | |
| 88% CPC + 10% corn oil + 2% | 60 | 5.5 | 92.8 | 132 | 22 |
| soy lecithin | | | | | |
| 80% CPC + 20% Palm Kernel Oil | 55 | 2.5 | 105 | 129 | 15 |
| 85% CPC + 15% Chicken Fat | 60 | 3.0 | 88.9 | 135 | 13 |

Inclusion % are on an as is basis

TABLE 22
Product Characteristics of Twin Screw Extruded CPC
and CPC with Other Added Ingredients

| | Bulk | Angle of | Texture |
|---|---|---|---|
| | Density | Repose | Analysis |
| Extruded Ingredients | (g/L) | (degree) | (g Force) |
| 100% CPC | 202 | 21.3 | 6033 |
| 100% CPC | 564 | 14.51 | 110455 |
| 90% CPC + 10% Tapioca Starch | 360 | 18.45 | 24388 |
| 70% CPC + 30% Soybean Protein | 436 | 19.67 | 73961 |
| Isolate | | | |
| 88% CPC + 10% corn oil + 2% soy | 662 | 23.17 | 50496 |
| lecithin | | | |
| 80% CPC + 20% Palm Kernel Oil | 653 | — | — |
| 85% CPC + 15% Chicken Fat | 267 | — | — |

When extruded without other ingredients, CPC had good expansion properties to make expanded or puffed pellets of several sizes, shapes and bulk density. Table 22 lists physical characteristics of various extrudates. Control of energy input into the system could be used to produce a pellet that was devoid of any mealy or gritty texture mouthfeel upon consumption; higher levels of shear and work improved texture and mouthfeel of extrudate when 100% CPC was extruded. Addition of tapioca starch increased expansion, but also increased water requirements. Samples with added starch did not expand as uniformly (e.g., shape and/or blistering) as those made with only CPC. Addition of soy protein isolate increased water requirements during extrusion, but inclusion of soy isolate provides a more balanced amino acid profile in the final product. A greater than 80% protein pellet could be produced by extruding a blend of CPC and soybean protein isolate. Incorporation of chicken fat, palm oil, soybean oil, and corn oil were tested at inclusion levels of 5, 10, 15, and 20%. Soy lecithin was also included at a 2% level with the various fats. Saturation level impacted extrudability; saturated fats such as palm oil resulted in the easiest incorporation. CGM also was tested for extrudability and in combination with other ingredients, but CGM had comparatively poorer extrusion performance, dark brown or carmel color, and did not bind oil as well as CPC.

### Example 12

### Further Processing by Hydrolysis

The CPC is further processed by heated refluxing in 2 N HCl for 1 hr at 90° C. to hydrolyze the protein. The hydrolyzed protein can be used as is as a higher solubility protein source or be further process by dehydration and heat application in the production of flavoring compounds to be further utilized in feed applications.

### Example 13

### Further Processing into a Palatant

The CPC is further processed by treatment with proteases. A portion of the hydrolyzed protein is further treated by mixing with 10% high fructose corn syrup and cooking the mixture at 350° F. for a time sufficient to produce meat-like flavors. The liquids are dried and applied separately or together onto a pet food to enhance the palatability of the food.

### Example 14

### Water Absorption and Solubility Indeces

Water absorption index and water solubility index of CGM and CPC was determined as outlined in American Association of Cereal Chemists (AACC) Official Methods 56-20 and also by Anderson et al., 1969, Cereal Science Today, 14 (1):4-11. Additionally, the % solubilized protein was calculated as the calculated percent of the original samples protein content that was measured in the supernatant after centrifuging as measured by AACC using an Elementar Variomax nitrogen analyzer and a protein conversion factor of 6.25. The CPC product released significantly more solids into the water solution (supernatant) than the CGM. WAI and the % protein in the supernatant were not statistically different. The results are shown in Table 23.

TABLE 23
WAI and WSI in water by Protein Products

| Product | WAI (%) | WSI (%) | % Solubilized Protein |
|---|---|---|---|
| CGM 1 | 252 | 3 | 4.1 |
| CGM 2 | 260 | 3 | 5.0 |
| CPC 1 | 253 | 6 | 5.7 |
| CPC 2 | 307 | 5 | 2.6 |

### Example 15

### Caustic Solubility Index

CPC and CGM samples from Example 14 were tested for solubility in 0.5 N sodium hydroxide based on methods and materials used in Example 14. CPC and CGM were placed in 0.5 N sodium hydroxide (NaOH) and mixed for 1 hr. The samples were centrifuged at 4000×g for 10 min and the supernatant collected. The % solubilized protein was measured in the supernatant after centrifugation as measured by AOAC 990.03 and was expressed as the percent of the protein content in the original samples. CPC unexpectedly had lower protein solubility (protein released into the solution) in a solution of 0.5 N sodium hydroxide (NaOH) than did the CGM. Results are shown in Table 24.

TABLE 24
Solubilized Protein in 0.5 N NaOH of CGM and CPC

| Product | % Solubilized Protein |
|---|---|
| CGM 1 | 74.3 |
| CGM 2 | 74.3 |
| CPC 1 | 28.8 |
| CPC 2 | 27.5 |

### Example 16

### Sodium Dodecyl Sufate Solubility Index

CPC and CGM solubility in a solution of 1% SDS was tested based on methods and materials used in Example 14. CPC and CGM were placed in 1% SDS and mixed for 1 hr. The samples were centrifuged at 4000×g for 10 min and the supernatant collected. The % solubilized protein was measured in the supernatant after centrifugation as measured by AOAC 990.03 and was expressed as the percent of protein content in the original sample. Slightly less protein (e.g., nitrogen) was released into solution from the CPC as compared to the CGM.

TABLE 25

| Product | % Solubilized Protein |
|---|---|
| CGM 1 | 11.8 |
| CGM 2 | 13.9 |
| CPC 1 | 10.4 |
| CPC 2 | 8.4 |

### Example 17

### Protease Digestibility

About 3 grams of protein material was suspended in 30 grams of water, to which an amount of enzyme was added and the mixture was incubated in a shaking waterbath at 50° C. for 20 hrs. Treatment 1 was an amount of 3 microliters of GC106 protease enzyme was added to each mixture of CPC or CGM and water (pH adjusted to 4.3). Treatment 2 was an amount of 50 microliters of each of GC106 and Proteinase T was added to each mixture (pH adjusted to 4.3). After incubating 20 hrs, each mixture was centrifuged at 4000 g for 15 minutes and the supernatant was tested for soluble protein content by AOAC 990.03. Results are shown in Table 26. No significant difference in protein digestibility was observed between CGM and CPC. Total protein digested by the proteases appeared dependant on both concentration and the type of protease used.

TABLE 26
% of Original CGM or CPC Protein (Nitrogen × 6.25) Released
into Solution with Protease Treatment

| | Enzyme Treatment (20 hr, 50° C., pH 4.3) | |
|---|---|---|
| Product | Treatment 1: GC106 | Treatment 2: Proteinase T + GC106 |
| CGM 1 | 11 | 27 |
| CGM 2 | 14 | 28 |
| CPC 1 | 11 | 28 |
| CPC 2 | 8 | 25 |

### Example 18

### Microbial Stability

Four samples of CPC or CGM were analyzed for microbiological and water activity. CPC had less bacterial counts as determined by a Standard Plate Count test conforming to AOAC 966.23 as shown in Table 27.

TABLE 27
Comparison of Standard Plate Counts of CPC compared to CGM

| Sample | Standard Plate Count |
|---|---|
| Corn Gluten Meal | 2000 |
| CPC Lot #1 | 450 |
| CPC Lot #2 | 220 |
| CPC Lot #3 | 460 |
| CPC Lot #4 | 330 |

### Example 19

### Deodorizing

A mixture of cyclodextrins (alpha-, beta-, and propylated-beta-) are applied to the filtered cake material of CPC. The cyclodextins may be applied in dry form and mixed with the cake or sprayed on in wet form. The treated cake is then dried in the presence of the cyclodextrin. The dried CPC has substantially less corn and/or wet milling associated odors than the untreated material.

### Example 20

### Deodorizing

An aqueous and alcohol solution of cyclodextrins was applied to finished CPC by a spray application in at two concentrations of about 0.1% and about 2% on a wt/wt basis. About 25 grams of CPC was placed in 150 ml sealed containers. Solutions of cyclodextrin or a control of water was applied to the CPC. The CPC was mixed and allowed to equilibrate for 5 minutes in a sealed container. The head-space within the container was tested by a sniff test of human judges. A panel of 6 judges unanimously found that the CPC treated with cyclodextrins had a significantly and substantially reduced odor commonly associated with the wet milling process. The treated product was described as having a corn-like note when applied at very low levels of about 0.1% to having a bland, lack of smell when the solution was applied at about 2%. The treated CPC may be dried. Alternatively, similar results are expected when applying cyclodextrins to CPC in dry form.

### Example 21

### 70% Ethanol Absorption Index

CPC solubility/absorption functionality in a solution of 70% ethanol:30% water with 0.3% mercaptoethanol was tested based on methods and materials used in Example 4 and those of as outlined in American Association of Cereal Chemists Official Methods 56-20 and also by Anderson et al., 1969, Cereal Science Today, 14 (1):4-11. The absorption index is calculated on the final pellet weight and is a compounded by both the retention of absorbed ethanol solution in the pellet as well as loss of weight due to solubilization of protein into solution. The centrifuged pellet from the CPC comparatively weighed more than the centrifuged pellets from CGM thus having a higher adsorption index.

TABLE 28
70% Ethanol Absorption Index by Protein Products

| Product | EtOH-AI |
|---|---|
| CGM 1 | 2.5 |
| CGM 2 | 2.4 |
| CPC 1 | 3.3 |
| CPC 2 | 3.6 |

### Example 22

### Oil Solubility and Adsorption Index

About 7 grams of protein material was suspended in 20 grams of corn oil and tumbled in 50 ml centrifuge tubes for 1 hour. The tubes were then centrifuged at 4500 g for 15 minutes and the supernatant oil was poured off. An amount of 20 grams of water was added and the pellet was resuspended by vortexing for 15 sec. The mixture was again centrifuged at the above conditions. The oil suspended was removed, dried and weighed and Oil Binding Index=weight of oil recovered/weight of protein material(db)*100. The supernatant water was further poured off the pellet and the pellet was dried. The increase in dry basis weight between the initial material and the dried pellet was determined and the Oil Adsorption Index=Weight increase of pellet(db)/weight of protein material(db)*100. Increase of dry basis weight of the protein material was assumed to be oil adsorbed during treatment. CPC adsorbed less oil onto particle surfaces than CGM control. Results are shown in Table 29.

TABLE 29
% Corn Oil Adsorbed and Bound by Protein Products

| Product | OAI | Oil Binding Index |
|---|---|---|
| CGM 1 | 109 | 1151 |
| CGM 2 | 111 | 1300 |
| CPC 1 | 103 | 1335 |
| CPC 2 | 103 | 1168 |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A feed product for a companion animal comprising a corn protein concentrate, wherein said corn protein concentrate is prepared by a process comprising:
contacting one or more protein containing materials with one or more wet-mill streams and one or more carbohydrases to produce at least one protein concentrate and at least one aqueous stream containing water-soluble carbohydrates; and
separating the protein concentrate from the aqueous stream containing water-soluble carbohydrates.

2. The feed product of claim 1, wherein the feed product is for a companion animal selected from the group consisting of dog, cat, bird, fish, potbelly pig, reptile, amphibian, and rodent.

3. The feed product of claim 1, wherein the feed product is pet food.

4. The feed product of claim 1, wherein the feed product is pet treats.

5. The feed product of claim 4, wherein the pet treat is a biscuit, bar, chew, cookies, kibble, or toy.

6. The feed product of claim 1, wherein the feed product is a nutritional supplement.

7. The feed product of claim 6, wherein the nutritional supplement is a biscuit, a bar, a chew, cookies, biscuits, kibble, an energy bar, an energy sauce or an energy drink.

8. The feed product of claim 1, wherein the feed product enhances palatability.

9. The feed product of claim 8, wherein the corn protein concentrate is applied onto the surface of a pet food.

10. The feed product of claim 1, wherein said feed product has greater palatability than corn gluten meal or a feed made with corn gluten meal.

11. The feed product of claim 1, where the feed product results in greater satiety than a feed product containing GCM when fed to an animal.

12. The feed product of claim 1, wherein the feed product allows for caloric density management.

13. The feed product of claim 1, wherein the feed product has a higher pH when compared to CGM.

14. The feed product of claim 13, wherein the pH is approximately 4.8 to 5.6.

15. An animal feed comprising the feed product of claim 1.

16. The feed product of claim 1, wherein the process further comprises defatting the protein-containing material.

17. The feed product of claim 1, wherein the process further comprises decoloring, bleaching, and/or reducing the color-bodies present in the protein-containing material.

18. The food product of claim 1, wherein the process further comprises contacting the corn protein concentrate with a deodorizing compound.

19. The food product of claim 18, wherein said deodorizing compound is a cyclodextrin.

20. The feed product of claim 1, wherein at least one of the one or more wet-mill streams is selected from the group consisting of steep liquor, light steep water, heavy steep liquor, or mixtures thereof.

21. The feed product of claim 1, wherein at least one of the one or more wet-mill streams is derived from a gluten concentrating or mill thickening wet-mill stream wherein the majority fraction of the mill stream is of a nitrogenous or protein content.

22. The feed product of claim 1, wherein at least one of the one or more protein-containing materials is selected from the group consisting of light gluten fraction, heavy gluten fraction, corn gluten concentrate, corn gluten meal, gluten cake, and mixtures thereof.

23. The feed product of claim 1, wherein at least one of the one or more carbohydrases is selected from the group consisting of alpha amylase, dextrinase, pullulanase, glucoamylase, hemicellulase, cellulase, and mixtures thereof.

24. The feed product of claim 1, further comprising contacting the one or more protein-containing materials with one or more phytases.

25. The feed product of claim 1, wherein said feed product is extruded.

26. The feed product of claim 25, wherein said extruded feed product comprises a minimum oil content of 10% and a maximum oil content of 30%.

27. The feed product of claim 26, wherein the oil is a vegetable oil.

28. The feed product of claim 27, wherein said vegetable oil is selected from the group consisting of corn oil, soybean oil, canola oil, palm oil, rapeseed oil, peanut oil, and sunflower oil.

29. The feed product of claim 26, wherein said oil is an animal oil.

30. The feed product of claim 29, wherein said animal oil is selected from the group consisting of chicken fat, tallow, white grease, lard, and fish oil.

31. An animal feed product comprising a corn protein concentrate, wherein said corn protein concentrate is prepared by a process comprising:
contacting one or more protein containing materials with one or more wet-mill streams and one or more carbohydrases to produce at least one protein concentrate and at least one aqueous stream containing water-soluble carbohydrates; and
separating the protein concentrate from the aqueous stream containing water-soluble carbohydrates.

32. The animal feed product of claim 31, wherein the feed is for an animal selected from the group consisting of chickens, turkeys, game birds, cattle, fish, pigs, sheep, wild birds, frogs, shrimp, snails, reptiles, amphibians, and rodents.

33. The animal feed product of claim 31, wherein the feed is an aquafeed.

34. The animal feed product of claim 31, wherein the feed contains less than 10% starch.

35. The animal feed product of claim 33, wherein the feed exhibits expansion characteristics that contribute to the feeds density such that the feed floats, suspends, and/or sinks in a manner that make the pellet more palatable.

36. The animal feed product of claim 31, wherein the feed provides a concentrated source of methionine to the diet.

37. The animal feed product of claim 31, wherein the protein in the feed has desirable rumen bypass properties.

38. A corn protein concentrate comprising at least about 80% protein on a dry weight basis, wherein said corn protein concentrate substantially lacks one or more exogenous polypeptides having saccharification enzyme activity.

39. A corn protein concentrate, wherein, when said corn protein concentrate is compared to corn gluten meal, said corn protein concentrate:
a) has a pH that consistently stays above about 5;
b) has a lower wet milling odor;
c) exhibits less bacterial counts; and/or
d) has a lower ash content on a per protein basis.

40. The concentrate of claim 39, wherein there is no significant difference in the protein digestibility by an animal between said corn protein concentrate and said corn gluten meal.

41. A corn protein concentrate that has a lower water activity than corn gluten meal at a moisture content of less than 10%.

42. A corn protein concentrate comprising at least about 80% protein on a dry weight basis, less than about 5% of granular starch and about 1% to about 10% liquefied starch carbohydrates and sugars.

43. The corn protein concentrate of claim 42, wherein at least 10% of the total water extractable carbohydrates (DP 1-13) from the liquefied starch carbohydrates are DP 5-13.

44. A corn protein concentrate, wherein, when said corn protein concentrate is compared to corn gluten meal following extrusion, said corn protein concentrate:
a) exhibits more controllable expansion;
b) exhibits greater expansion;
c) exhibits more uniform cell structure;
d) creates a more homogenous product;
e) produces a kibble with a smoother surface; and/or
f) exhibits greater oil binding capacity.
